(19) United States
(12) Patent Application Publication
(10) Pub. No.: US 2008/0152014 A1
(43) Pub. Date: Jun. 26, 2008

(54) METHOD AND APPARATUS FOR ENCODING AND DECODING OF VIDEO STREAMS

(75) Inventors: Ralf Michael Schreier, Vienna (AT); Florian Seitner, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (AT)

(21) Appl. No.: 11/956,565

(22) Filed: Dec. 14, 2007

Related U.S. Application Data
(60) Provisional application No. 60/871,141, filed on Dec. 21, 2006.

(51) Int. Cl. H04N 7/26

(52) U.S. Cl. 375/240.21; 375/E07.188

(57) ABSTRACT

A method and processor to encode and/or decode a video stream exploiting frame-level parallelism. Frames of the video stream are encoded and/or decoded using M processing units where each processing unit processes one different frame at a time. Each processing unit writes the reconstructed frame to a frame buffer. A processing unit can start the encoding and/or decoding process once sufficient data of the previous reconstructed frame are available.

### CROSS-REFERENCE TO RELATED APPLICATION

This application claims priority from U.S. Provisional Patent Application Ser. No. 60/871,141 entitled “Method and Apparatus for Encoding and Decoding of Video Streams,” filed Dec. 21, 2006 and which is hereby incorporated by reference in its entirety.

### TECHNICAL FIELD

The invention relates in general to digital video encoding and decoding and in particular to digital video encoding and decoding which exploits frame-level parallelism.

### BACKGROUND

Video compression is a process where, instead of transmitting a full set of data for each picture element or pixel on a display for each frame, a greatly reduced amount of data can be coded, transmitted, and decoded to achieve the same perceived picture quality. Generally, a pixel is a small dot on a display wherein hundreds of thousands of pixels make up the entire display. A pixel can be represented in a signal as a series of binary data bits. Compression of data often utilizes the assumption that data for a single pixel can be correlated with a neighboring pixel within the same frame and the pixel can also be associated with itself in successive frames. A frame is a segment of data required to display a single picture or graphic. A series of consecutive frames is required to make a video image.

Since a value of a pixel can be predicted with some statistical error using neighboring pixels or pixels in consecutive frames, most video encoders use a two-stage hybrid coding scheme to compress and decompress video signals. Such a hybrid process combines a spatial transform coding for a single frame (reproducing pixel data based on neighboring pixels) with temporal prediction for the succession of frames (reproducing pixel data as it changes between frames).

Spatial transform coding can reduce the number of bits used to describe a still picture. Spatial transformation or intra-coding can include transforming image data from a spatial domain into a frequency-domain utilizing a discrete cosine transform (DCT), wavelets, or other processes. Subsequently, resulting coefficients can be quantized where low-frequency coefficients usually have a higher precision than high frequency coefficients. Afterwards, lossless entropy coding can be applied to the coefficients. By using transform coding, significant lossy image compression can be achieved whose characteristics can be adjusted to provide a pleasing visual perception for viewers.

Likewise, temporal prediction in streaming video can provide intra-coded frames to establish a baseline refresh, and then successive frames can be described digitally by their difference from another frame. This process is referred to as “inter-coding.” The “difference” data or signal, which has significantly less energy (which results in less data) than the full data set, is usually transformed and quantized similarly to the intra-coded signal but with different frequency characteristics. Inter-coding can provide a superior result over intra-coding if motion compensated prediction is combined with inter-coding. In this case, an unrestricted reference frame area in a reference frame is searched to locate an area which matches as closely as possible the texture of an area to be coded for a current frame. Then, the difference signals and the calculated motion can be transmitted in an inter-coded format. Traditional systems often restrict certain regions from being utilized as baseline data to reduce error propagation. All such encoding (i.e., intra-coding and inter-coding) is often referred to generically as data compression.

Inter-coded transmissions utilize predicted frames, where predicted frames occur when the full set of data is not transmitted, but information regarding how the frame differs from a reference frame is utilized to “predict” and correspondingly construct the current frame. As stated above, intra-frame encoding is the creation of encoded data from a single image frame where inter-frame encoding is the creation of encoded data from two or more consecutive image frames. The temporal prediction of frames is theoretically lossless, but such prediction can lead to a serious degradation in video quality when transmission errors occur and these transmission errors get replicated in consecutive frames. For example, if an error occurs in some content and subsequent transmissions rely on the content to predict future data, the error can multiply causing widespread degradation of the video signal. In order to avoid infinite error propagation, intra-coded reference frames can be utilized to periodically refresh the data. The intra-coded data can be decoded “error-free” because it is independent of the previous possibly corrupt frames. Furthermore, the intra-coded frames can be used as an “entry point” or start point for decoding a compressed video data stream.

In short, a video stream consists of a series of frames. Compressed video signals consist of intra-coded frames (“intra-frames”) and inter-coded frames (“inter-frames). Intra-frame coding compresses each frame individually where each frame is intra coded without any reference to other frames. However, inter-frames are coded based on some relationship to other frames and exploit the interdependencies of a sequence of frames using prediction and compensation as described above. Intra-frames are termed I-frames. Inter-frames are termed P-frames, if one reference frame is used for the prediction. Inter-frames are termed B-frames, if two or more reference frames are used.

FIG. 2 shows a block diagram of a prior art structure of a video encoder. The encoder can be operated in an intra-mode whereby a switch 214 is set to position “0.” Frames coded in the intra-mode are intra predicted. A difference signal generated by a subtractor module 216 is processed by an orthogonal transforming unit 218, and quantized by a quantization unit 220. The coded signal is then output to a succeeding stage which normally compresses the signal for transmission, storing, or further processing.

In an encoder as shown in FIG. 2, video compression normally is achieved by using prediction of images as discussed above. Previous frames are required for the prediction reconstructed. To calculate the reconstructed image, inverse quantization is applied on the coded signal by an inverse quantization module 222 and, subsequently, an inverse orthogonal transformation step performed by an inverse orthogonal transformation module 224. A reconstructed intra-mode frame 227 is stored in a frame buffer 230. The reconstructed current frame 227 is used for an inter-prediction of the next frame. Inter-prediction requires at least one reconstructed previous frame 231 which is also read from the frame buffer 230.

If the encoder shown in FIG. 2 is operated in a non-intra-mode (i.e., a predicted mode) the switch 214 is switched as depicted in FIG. 2. A motion estimator 210 uses the current frame and the reconstructed previous frame 231 to determine motion information required by a predictor 212. The reconstructed previous frame 231 is loaded from the frame buffer 230. In the example shown in FIG. 2, the predictor 212 can calculate a predicted frame 213 using the motion information received from motion estimator 210 and the reconstructed previous frame 231. The subtractor module 216 calculates the difference image of the predicted frame 213 and the current frame. Similar to the intra-mode, the encoder which now is operated in a predicted mode calculates the coded signal by applying orthogonal transformation and quantization using the orthogonal transforming unit 218 and the quantization unit 220, respectively.

Some video standards allow combining inter-prediction and intra-prediction within a predicted frame on macroblock level. That is, in this case some macroblocks can be intra-coded and some can be inter-coded. However, to ease understanding of the present invention, a combination of intra- and inter-prediction within a frame is not explained further. However, the lack of further explanation must not be understood to limit a scope of the present invention.

The reconstructed difference frame 225 is computed from the output signal by applying inverse quantization and inverse transformation using the inverse quantization module 222 and the inverse orthogonal transformation module 224, respectively. Deblocking modules and other optional modules (depending on the video standard used) are not explained further but must not be understood to limit a scope of the present invention. The reconstructed current frame 227 is generated by an adder 226 from the predicted frame 213 and the reconstructed difference frame 225. The reconstructed current frame 227 then is stored in the frame buffer 230 which also holds the reconstructed previous frame 231.

FIG. 12 shows a block diagram of a prior art structure of a video decoder. A sequence of encoded frames is decompressed by an entropy decoder 510 and an inverse quantization module 514 and an inverse orthogonal transformation module 516 perform the inverse quantization and inverse orthogonal transformation operations, respectively and compute a difference frame. A predictor 512 calculates a predicted frame from information received from the entropy decoder 510 and additionally, in case of a predicted frame, from a reconstructed previous frame which is used as a reference frame. If a frame was coded in intra-mode, no reference frame is required. The difference frame calculated by the inverse orthogonal transformation module 516 and the predicted frame calculated by the predictor 512 are combined into a reconstructed current frame which is stored in a frame buffer 520 as well. Similar to the encoder described above, the prior art decoder structure shown in FIG. 12 stores the reconstructed previous frame and the reconstructed current frame.

A frame can be divided into slices. A slice can be a vertical area of a frame. A simple example of such a slice of a frame is to horizontally split the frame in the middle. The upper part of the frame and the lower part of the frame can be of equal size and can be encoded or, if supported by an encoded video stream, decoded independently. The independent decoding requires that there are no dependencies between slices of a frame.

A macroblock is a block of data that describes a group of spatially adjacent pixels. A macroblock usually defines pixels in a rectangular region of the frame where the data in a macroblock can be processed together and somewhat separately from other macroblocks. Thus, a frame can be divided into numerous macroblocks and macroblocks are often defined in a matrix topology where there are x and y macroblocks. A macroblock can therefore have a designation such as, for example, (2, 3) where x and y can range from 1 to Z.

Often, the most obvious distortion or artifacts in a video stream are the appearance of square or rectangular blocks in the decoded frame. Such artifacts are characteristic to block-based compression methods that make use of macroblocks. To reduce blocking distortion, a deblocking filter is applied to each decoded macroblock. The deblocking filter is applied after the inverse transformation in the encoder and in the decoder. The appearance of the decoded frames is improved by smoothing the block edges. The frame filtered by this technique is used for motion-compensated prediction of future images.

A Group of Pictures (GOP) is a group of successive frames within a coded video stream. The GOP specifies the order in which frames are arranged. The frames of the GOP can be intra-frames or inter-frames. An arrangement of frames of subsequent GOPs can be kept constant for the whole video stream or for parts of the video stream.

Although state-of-the-art video compression standards provide high compression rates and even allow one to maintain high picture quality, the compression standards require a lot of computational resources to encode the frames with a reasonable size and quality. High data throughput and high processing power are required. Therefore, parallelization is of high importance in architectures used for video encoding and decoding. However, common standards for video encoding and decoding strongly restrict the degree of parallelization. Therefore, one of the basic problems in video encoder and decoder development is to find the best way to split the encoding task of a video stream for parallel processing. A variety of parallelism methods are available in the art. Methods have to handle high data throughput and the high processing power requirements. However, some disadvantages of known methods are asymmetric usage of the parallel processing units, reduced compression efficiency, and complex handling of boundary regions between parallel-processed data blocks. The present invention presents a new parallelization method that overcomes disadvantages of known solutions.

Known kinds of parallelization mechanisms exploit parallelism in space, function, and time. In spatial parallelism, a frame is split into regions where each region is processed independently from one another. In functional parallelism, each processing unit runs different functions. For instance, one processing unit runs motion estimation and another processing unit runs a discrete cosine transformation, etc. Temporal parallelism exploits time displacement of frames. These kinds of parallelization mechanisms may be applied separately or can be combined.

Nang et al. discloses in, “An Effective Parallelizing Scheme of MPEG-1 Video Encoding,” state-of-the-art mechanisms of parallization methods which are commonly in contemporaneous use and to which practitioners are often referred. Four parallization methods are identified as attractive parallelisms and are discussed in a series of experiments: macroblock-level, slice-level, frame-level, and GOP-level parallelism. Although published in 1997, this publication of Nang et al. is still cited by a series of other publications in the art and the parallization methods discussed are still applied in today's video encoders and decoders.

Iwata et al. describes in U.S. Pat. No. 6,870,883, entitled “Parallel Encoding and Decoding Processor System and Method,” a macroblock-level and slice-level parallel method which uses parallel processors to encode or decode macroblocks of a frame in parallel.

In general, macroblock parallelism enables encoding and decoding on parallel processing systems. However, strong dependencies exist between successive macroblocks. Further, macroblock parallelism results in a large amount of data that has to be transferred between processors. Due to strong differences in the computational time between macroblocks, the method disclosed by Iwata et al. has poor processor load. Other implementations which exploit macroblock-level parallelism even need additional and sophisticated workload balancing mechanisms to distribute the tasks among the processors.

Another method of parallelization is slice-level parallelism. Each frame is divided into two or more slices. Common video standards enable one to independently encode or decode the slices of a frame. The data dependencies between the slices are removed by not applying deblocking or prediction beyond slice borders. This result in greatly reduced compression efficiency and visual artifacts at slice borders. Optionally deblocking at slice borders must be done sequentially without efficient usage of the parallel units.

Knee et al. discloses in U.S. Pat. No. 5,640,210 entitled “High Definition Television Coder/Decoder which Divides an HDTV Signal into Slices for Individual Processing,” a method and apparatus that exploits slice-level parallelism. Each slice is coded or decoded by a single sub-coder or sub-decoder. Every N^{th} slice is coded or decoded by the same sub-coder/sub-decoder. The method of Knee et al. is shown in FIG. 1A. A de-multiplexer 10 can receive frames from an input signal. The slices of the frame are forwarded to a plurality of sub-coders/sub-decoders 11 which process the slices independently. A multiplexer 12 composes processed output of the plurality of sub-coders/sub-decoders 11 to an output signal.

Kimura et al. discloses in U.S. Pat. No. 7,701,160 entitled “Image Encoding and Decoding Apparatus,” an image encoding or decoding apparatus having a circuit for dividing a frame into slices to conduct an encoding or decoding operation for each slice, a code integrating circuit for integrating the codes of the respective slices, and a shared memory for storing frames locally.

FIG. 1B shows an example of a sequence of frames 20. Each frame 20 is split horizontally in the middle and two processors are used for the encoding or even the decoding process. An upper slice 21 of each frame 20—slice A—is computed on a processor 1, a lower slice 22 of each frame 20—slice B—is computed on a processor 2. However, the mechanism can easily be extended for more than two slices and, hence, allows easy parallelization. A disadvantage of such an approach is that decoders can only exploit slice-level parallelism if they receive an input video stream which has been encoded with frames split in slices. In other words, the encoder determines the degree of slice-level parallelism which can be applied in the decoder.

However, problems of approaches exploiting slice-level parallelism appear at the slice boundaries: no prediction is possible beyond slice boundaries and with each additional slice the efficiency of exploiting spatial or temporal similarities is reduced. Furthermore, deblocking at the slice boundaries cannot be performed since it requires data from both slices for the filter operations. This results in visible blocking artifacts at the slice borders (sharp horizontal borders are visible in the image).

GOP-level parallelism is a kind of temporal parallelism. A decoder which exploits GOP-level parallelism splits the incoming stream into independent GOPs and decodes them on independent decoders. The parallel-decoded GOPs are put in the correct order by an output module. Such a system is disclosed in U.S. Pat. No. 5,883,671 to Keng et al. entitled “Method and Apparatus for Partitioning Compressed Digital Video Bitstream for Decoding by Multiple Independent Parallel Decoders.”

Tiwari et al. discloses in U.S. Pat. No. 5,694,170 entitled “Video Compression Using Multiple Computing Agents,” a system and method which uses multiple processors to perform video compression. A video sequence (i.e., an input signal) is partitioned into sub-sequences. Processing assignments for the sub-sequences are distributed among a plurality of processors. A frame type (whether it is an I-frame, P-frame, or B-frame) is then determined for each frame in each sub-sequence. Each frame is then compressed in accordance to its associated frame type.

Advantages of GOP-level parallelism include easy implementation and complex dependencies among the frames can be circumvented easily. However, disadvantages of GOP-level parallelism include a very high latency since parallel processing units operate on whole GOP data sets (thereby making such a system unsuitable for real-time live video streaming), high memory requirements, and difficult rate control issues.

Hence, favorable parallelism would include lower minimal requirements of memory sizes, higher throughput, and increased processing power of the parallel processing elements. Moreover, favorable methods of parallelism should support real-time steaming and even enable high picture quality without artifacts as they occur in known methods which exploit slice-level parallelism.

Frame level-parallelism allows parallel encoding and/or decoding of whole frames instead of groups of frames (GOPs) or parts of it (e.g., slices or macroblocks). The most obvious issues in frame-level parallelism are the interdependencies of frames in predicted video coding to previous reconstructed frames.

### SUMMARY OF THE INVENTION

A method and processor to encode and/or decode a video stream exploiting frame-level parallelism is disclosed. The frames of the video stream are encoded and/or decoded using M processing units where each processing unit processes one different frame at a time. Each processing unit writes the reconstructed frame to a frame buffer. The next processing unit can use the reconstructed frame from that frame buffer as a reference frame.

The parallel encoding or decoding stages may be coupled via the frame buffers. A stage can read data from the input and reconstructed previous frames from previous stages by accessing the frame buffers of previous stages and can write a reconstructed frame to a frame buffer which is assigned to the current processing unit. A processing unit which runs an encoder or a decoder can start the encoding and/or decoding process once sufficient data of the reconstructed previous frame are available. A stream merging unit merges the output of all stages to at least one output stream.

In one exemplary embodiment, the present invention is a video encoding apparatus which includes a divider circuit configured to divide an input video stream into a plurality of single frames and a plurality of encoding units coupled to the divider. Each of the plurality of encoding units is configured to receive at least one of the plurality of single frames. Each of a plurality of shared information memory units are coupled to and associated with at least one of the plurality of encoding units. Each of the plurality of encoding units is configured to write a reconstructed frame to at least one of the plurality of shared information memory units, and each of the plurality of shared information memory units is configured to distribute a frame reproduced by an associated encoding unit to at least one other encoding unit. A control unit is coupled to the plurality of encoding units and configured to determine which frame of a sequence of frames is processed by which of the plurality of encoding units. A stream merging unit is configured to assemble the coded signals produced by the encoding units into at least one output stream.

In another exemplary embodiment, the present invention is a method of encoding a video sequence exploiting frame-level parallelism. The method includes partitioning a video sequence into a plurality of frames, distributing the plurality of frames among a plurality of encoding units, encoding the plurality of frames according to a picture type assigned to each of the plurality of frames, assigning at least one shared information memory unit from a plurality of shared information memory units to each of the plurality of encoding units, storing reconstructed frames created by the plurality of encoding units to at least one of the plurality of shared information memory units, controlling which frame of the plurality of frames is processed by a specific one of the plurality of encoding units, and determining when a sufficient amount of data of the reconstructed frames are available for encoding in each of the information memory units.

In another exemplary embodiment, the present invention is a video decoding apparatus coupled to receive an encoded input video stream having a sequence of coded frames. The apparatus includes a divider circuit configured to divide the input video stream into a plurality of single coded frames and transfer at least one of the plurality of single coded frames to a plurality of decoding units and a plurality of shared information memory units. Each of the plurality of shared information memory units is coupled to and associated with at least one of the plurality of decoding units. Each of the plurality of decoding units is configured to write a reconstructed frame to at least one of the plurality of shared information memory units and each of the plurality of shared information memory units is configured to distribute a frame reproduced by an associated decoding unit to at least one other decoding unit. A control unit is coupled to the plurality of decoding units and configured to determine which frame of a sequence of frames is processed by which of the plurality of decoding units. A stream merging unit is configured to assemble the coded signals produced by the decoding units into at least one output stream.

In another exemplary embodiment, the present invention is a method of decoding a coded video sequence exploiting frame-level parallelism. The method includes partitioning a video sequence into a plurality of coded frames, distributing the plurality of coded frames among a plurality of decoding units, decoding the plurality of coded frames according to a picture type assigned to each of the plurality of coded frames, assigning at least one shared information memory unit from a plurality of shared information memory units to each of the plurality of decoding units, storing reconstructed frames created by the plurality of decoding units to at least one of the plurality of shared information memory units, controlling which frame of the plurality of coded frames is processed by a specific one of the plurality of decoding units, and determining when a sufficient amount of data of the reconstructed frames are available for decoding in each of the information memory units.

### BRIEF DESCRIPTION OF THE DRAWINGS

The appended drawings illustrate exemplary embodiments of the invention and are not to be considered as limiting a scope of the present invention.

FIG. 1A shows an encoder of the prior art which uses slice-level parallelism.

FIG. 1B shows a prior art example of a sequence of frames. Each frame is split horizontally in the middle into two slices. Two processors can be used for the encoding or decoding process.

FIG. 2 shows a block diagram of a prior art structure of a video encoder.

FIG. 3 shows, in simplified form, an exemplary embodiment of the present invention. Two encoders (encoder stages 1 and 2) of the type shown in FIG. 2 are coupled via frame buffers which each can hold a reconstructed frame or portions of the reconstructed frame.

FIG. 4 graphically depicts an exemplary embodiment of a possible encoding process in which a coupled encoder of FIG. 3 is used.

FIG. 5 shows another exemplary embodiment of an encoding process expressed as a function of time using the encoding process depicted in FIG. 4.

FIGS. 6A and 6B shows, in simplified form, an exemplary embodiment of the present invention. Three encoders (encoder stages 1, 2, and 3) of the type shown in FIG. 2 are coupled via frame buffers which each can hold a reconstructed frame or portions of the reconstructed frame.

FIG. 7 graphically depicts an exemplary embodiment of a possible encoding process in which a coupled encoder of FIGS. 6A and 6B is used.

FIG. 8 shows an example of an encoding process expressed as a function of time using the encoding process depicted in FIG. 7.

FIG. 9 shows an exemplary embodiment of an encoding apparatus according to the present invention where processing units P1, P2, and P3 may use only a single reconstructed previous frame as a reference frame.

FIG. 10 shows an exemplary embodiment of an encoding apparatus according to the present invention where processing units P1, P2, and P3 can use all available reconstructed previous frames as reference frames.

FIG. 11 shows another exemplary embodiment of an encoding process as a function of time. The encoding process has been depicted in FIG. 7.

FIG. 12 shows a block diagram of a prior art structure of a video decoder.

FIG. 13 shows, in simplified form, an exemplary embodiment of the present invention. Two decoders (the decoder stages 1 and 2) of the type shown in FIG. 12 are coupled via frame buffers which each can hold a reconstructed frame or portions of the reconstructed frame.

FIG. 14 shows, in simplified form, an exemplary embodiment of the present invention. Three decoders (the decoder stages 1, 2, and 3) of the type shown in FIG. 12 are coupled via frame buffers which can each hold a reconstructed frame or portions of a reconstructed frame.

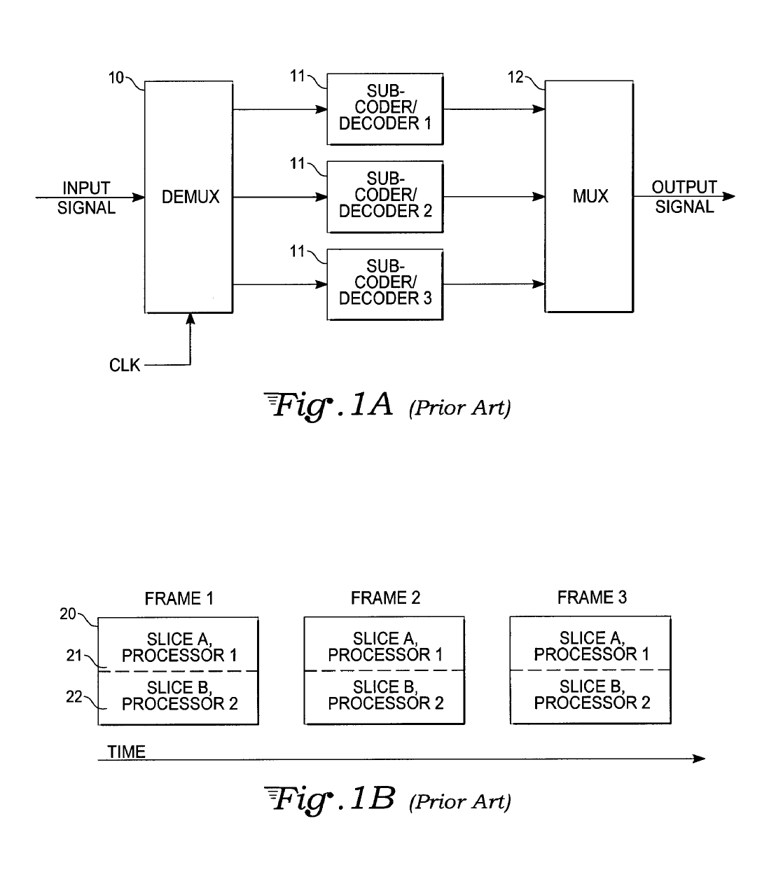

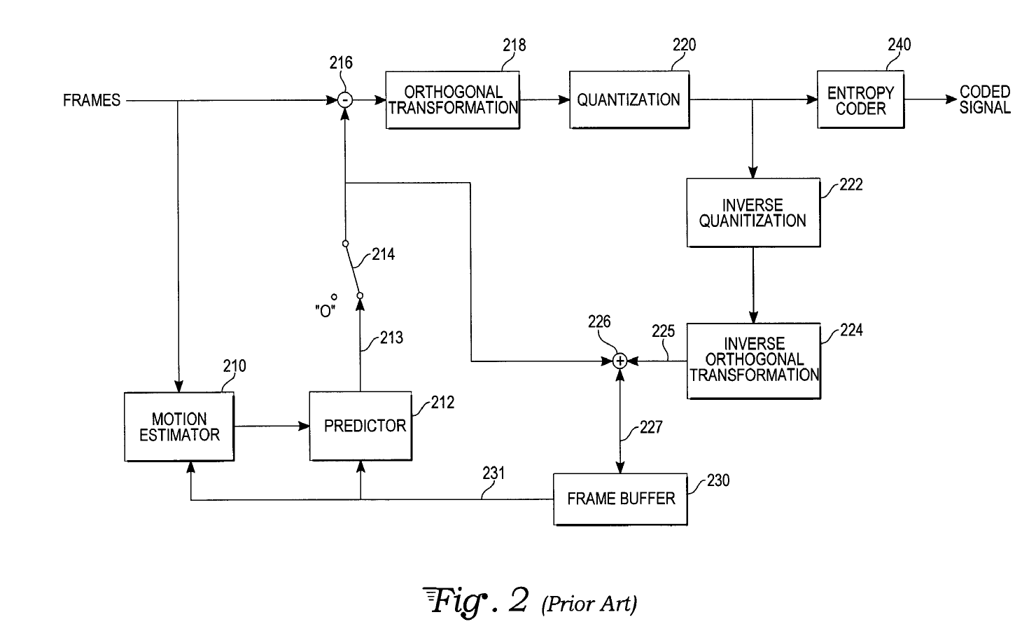

### DETAILED DESCRIPTION

In the following description, a new method and apparatus to encode and/or decode a video stream exploiting frame-level parallelism is disclosed. The frames of the video stream are encoded and/or decoded using M processing units where each processing unit processes one different frame at a time. Each processing unit can write a reconstructed frame to a frame buffer. A subsequent processing unit can use the reconstructed frame from that frame buffer as a reference frame. Hence, the processing units are connected via the frame buffers. The frame processing occurs time-displaced and can start when sufficient input data are available and, if necessary, if sufficient data of the reconstructed previous frame which was calculated in a previous stage are available.

As explained above with reference to FIG. 2, the frame buffer 230 in known architectures stores at least two frames: the reconstructed previous frame 231 and the reconstructed current frame 227. The method and apparatus presented in various embodiments of the present invention splits those reconstructed frames and makes use of temporal parallelism.

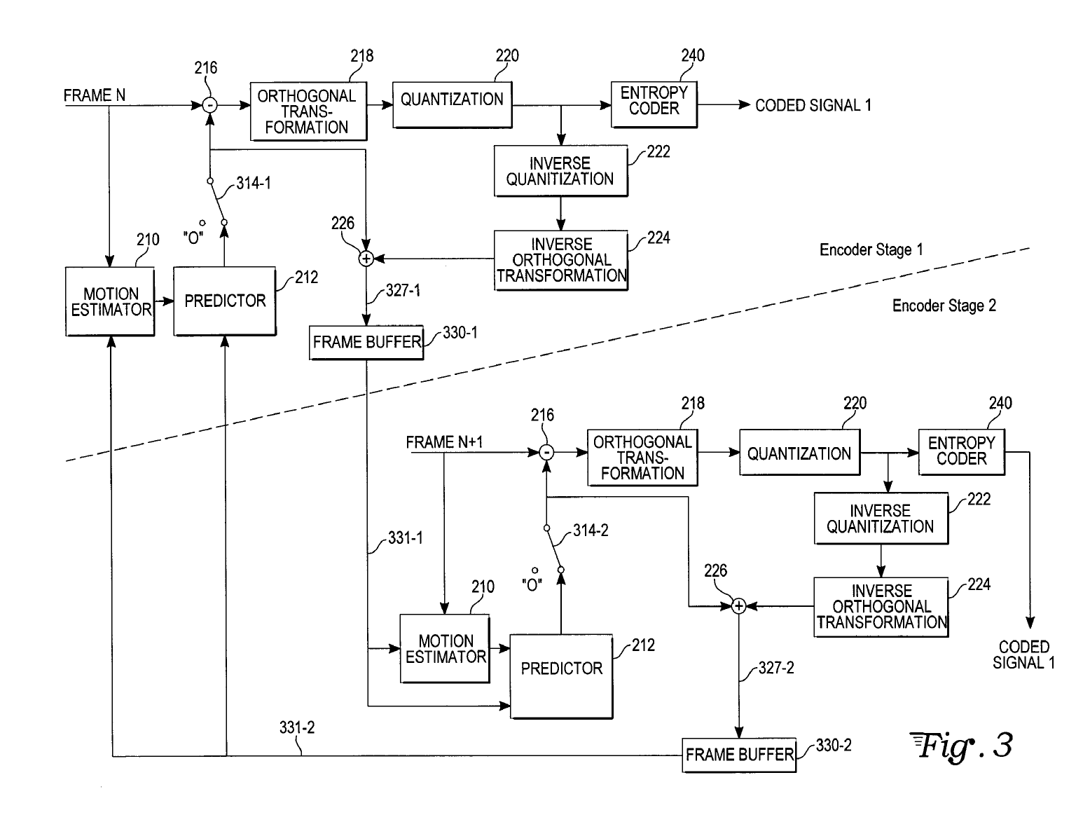

FIG. 3 shows two coupled encoders of the type shown in FIG. 2: an encoder stage 1 and an encoder stage 2. The circuit receives a current frame N and a next frame N+1 and outputs a coded signal 1 which is the coded frame N and a coded signal 2 which is the coded frame N+1. The circuit shown in FIG. 3 comprises similar modules as used in the circuit shown in FIG. 2. However, a first 330-1 and second 330-2 frame buffer can be much smaller than the frame buffer 230 (e.g., about half of the size of the frame buffer 230) as each of the first 330-1 and second 330-2 buffers stores only one frame instead of two. That is, the first frame buffer 330-1 can store the reconstructed frame N which is the reconstructed current frame for the encoder stage 1 and the second frame buffer 330-2 can store the reconstructed frame N+1 which is the reconstructed current frame of the encoder stage 2.

Together, the encoder stage 1 and the encoder stage 2 shown in FIG. 3 can be operated at half of the speed of the encoder shown in FIG. 2, which will be discussed below. When the encoder stage 1 starts encoding of the first frame of the input video frame sequence, the encoder stage 2 is idle. The encoder stage 1 of FIG. 3 stores a reconstructed current frame 327-1 in the first frame buffer 330-1. The encoder stage 2 can start the encoding process of frame N+1 when a sufficient portion of the input frame N+1 and a sufficient amount of a reconstructed previous frame 331-1 are available. Therefore, it is not necessary to store the whole reconstructed current and reconstructed previous frame for both the encoder stage 1 and the encoder stage 2.

When an encoder has coded a certain amount of image data of a frame N, e.g., encoder 1 has encoded and reconstructed the upper half input image N, in most cases enough reconstructed image data are available for the motion estimation step in the encoding process of image N+1. The reference frame area for the motion estimation in the encoding process of image N+1, thus, has to be limited to the image data already processed.

FIG. 4 shows an exemplary graphical representation of the encoding process in the circuit of FIG. 3. The encoder stage 1 in a two-stage frame-level encoder is processing a first macroblock 511 of frame N. The encoder stage 2 is processing a second macroblock 512 of frame N+1. The encoder stage 2 searches within the bounds of a reference frame area 510 within frame N for suitable reference pixels that are used for temporal prediction. As both encoders in the example process the macroblocks line by line from top down and each line from left to right, a region 515 defines the reconstructed image data that has to be stored in the reconstructed previous frame buffer 330-1 of the encoder 1. As a result, in the embodiment shown in FIG. 3, the reference frame area below the currently processed macroblock which is used in the motion estimators 210 shall be limited to maximal half of the image height.

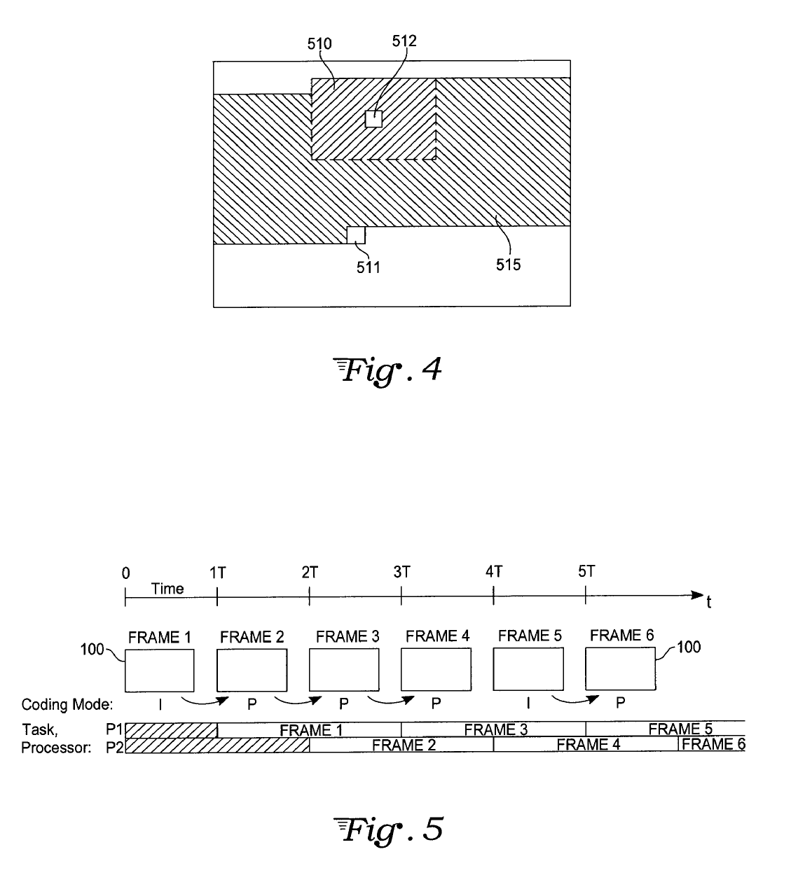

FIG. 5 shows an exemplary timing diagram of the encoding process. The frames are received sequentially each period of 1T of time. A progress bar at the bottom of FIG. 5 shows the progress of the encoding process of a frame for each encoder stage. In FIG. 5 the encoder 1 is termed P1 and the encoder 2 is termed P2. Once frame 1 is available the encoder P1 can start the encoding process of frame 1. In other exemplary embodiments described herein, the encoder P1 can start with the encoding process when only portions of the frame are available. The encoder P1 can use up to 2T of time to encode a frame.

Once the second frame is received, encoder P2 can start the encoding process of frame 2. In other embodiments of the disclosure, the encoder P2 can start with the encoding process when only portions of the frame are available. Hence, the encoder P2 can use just parts of the reconstructed frame 1 calculated by encoder P1. Therefore, both encoders use a limited reference frame area as discussed above. The encoder P2 can use up to 2T of time to encode a frame as well. As soon as the encoder P1 has completed the encoding of frame 1 it can start with the encoding process of frame 3 using the reconstructed frame 2 stored in the frame buffer 330-2 (FIG. 3) which was generated by the encoder P2 during the encoding process of frame 2. In turn, as soon as the encoder P2 has completed the encoding of frame 2 it can start with the encoding process of frame 4 using the reconstructed frame 3 stored in the frame buffer 330-1 which was generated by the encoder P1 during the encoding process of frame 3.

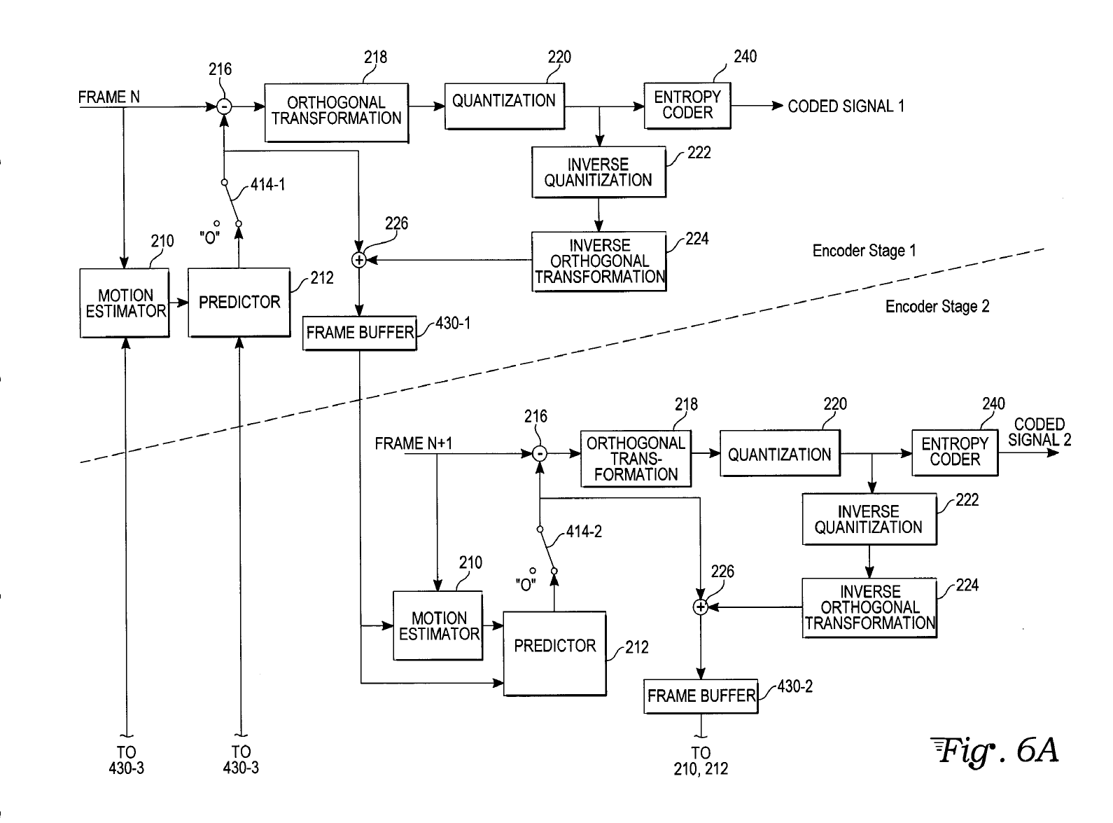

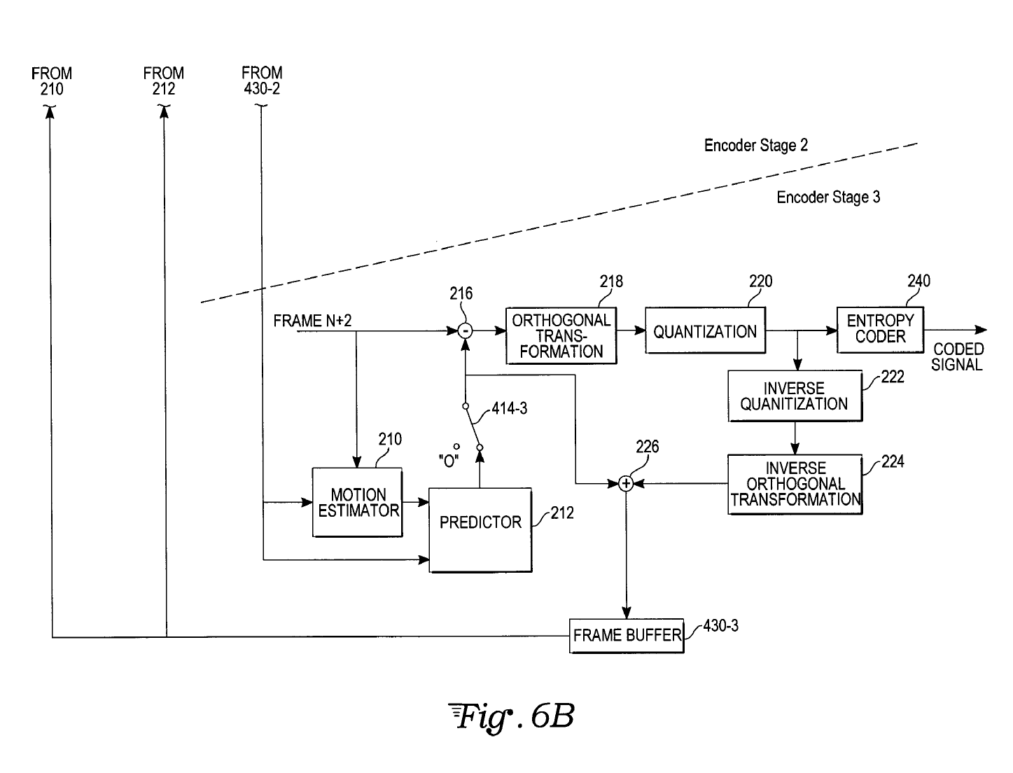

FIGS. 6A and 6B show another exemplary embodiment of the present invention in which three coupled encoders are used of the type shown in FIG. 2: an encoder stage 1, an encoder stage 2, and an encoder stage 3. The circuit receives a current frame N, a frame N+1, and a frame N+2. The circuit outputs a coded signal 1 which is the coded frame N, a coded signal 2 which is the coded frame N+1, and a coded signal 3 which is the coded frame N+2. The encoders used in FIGS. 6A and 6B comprise similar modules as used in the circuit shown in FIG. 2. However, a first 430-1, second 430-2, and third 430-3 frame buffers can be much smaller than the frame buffer 230 of FIG. 2 (i.e., about one third of the size of the frame buffer 230) and each of the first 430-1, second 430-2, and third 430-3 frame buffers stores only one frame instead of two.

The encoder stage 1 can forward its reconstructed frame to the encoder stage 2 using the first frame buffer 430-1, the encoder stage 2 can forward its reconstructed frame to the encoder stage 3 using the second frame buffer 430-2, and the encoder stage 3 can forward its reconstructed frame back to the encoder stage 1 using the third frame buffer 430-3.

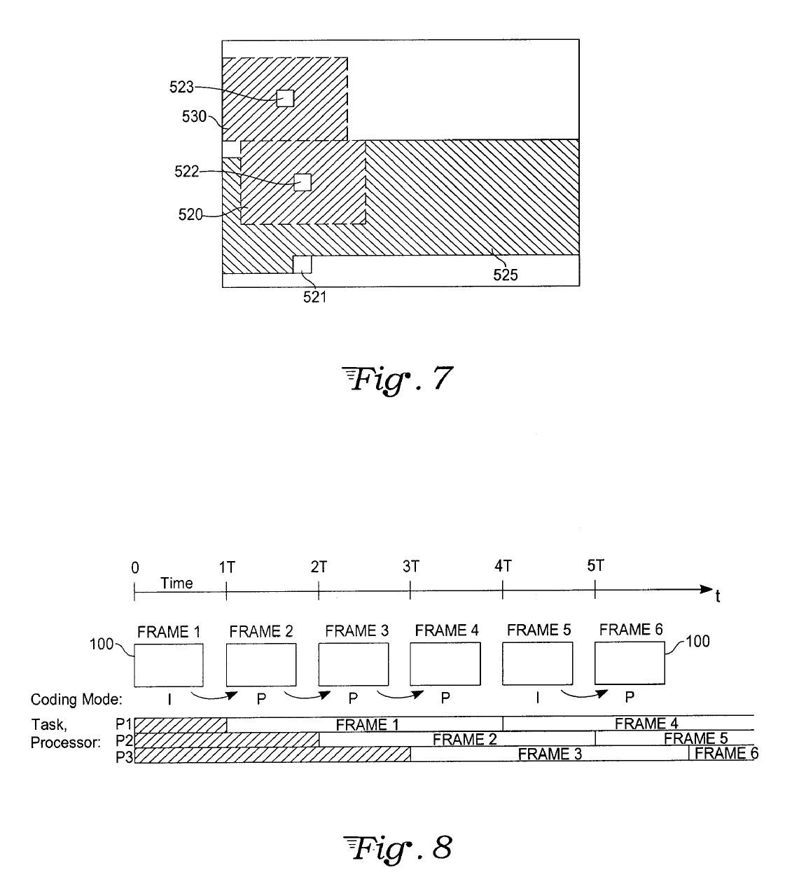

FIG. 7 shows an exemplary encoding process of the three encoder stages of FIGS. 6A and 6B graphically. The encoder stage 1 in a three-stage frame-level encoder of FIGS. 6A and 6B is processing a first macroblock 521 of frame N. The encoder stage 2 is processing a second macroblock 522 of frame N+1 and the encoder stage 3 is processing a third macroblock 523 of frame N+2. The encoder stage 2 searches within the bounds of a reference frame area 520 within frame N for a suitable block of pixels that is used for motion estimation in the reconstructed image data of the encoder stage 1. A first region 530 denotes a reference frame area of the encoder stage 3 within the reconstructed image data of the encoder stage 2. Again, the three encoders in the example process the macroblocks line by line from top down and each line from left to right. A second region 525 defines the reconstructed image data that have to be stored in the reconstructed previous frame buffer 430-1 of the encoder stage 1. The reconstructed image data stored in the second frame buffer 330-2 are not shown.

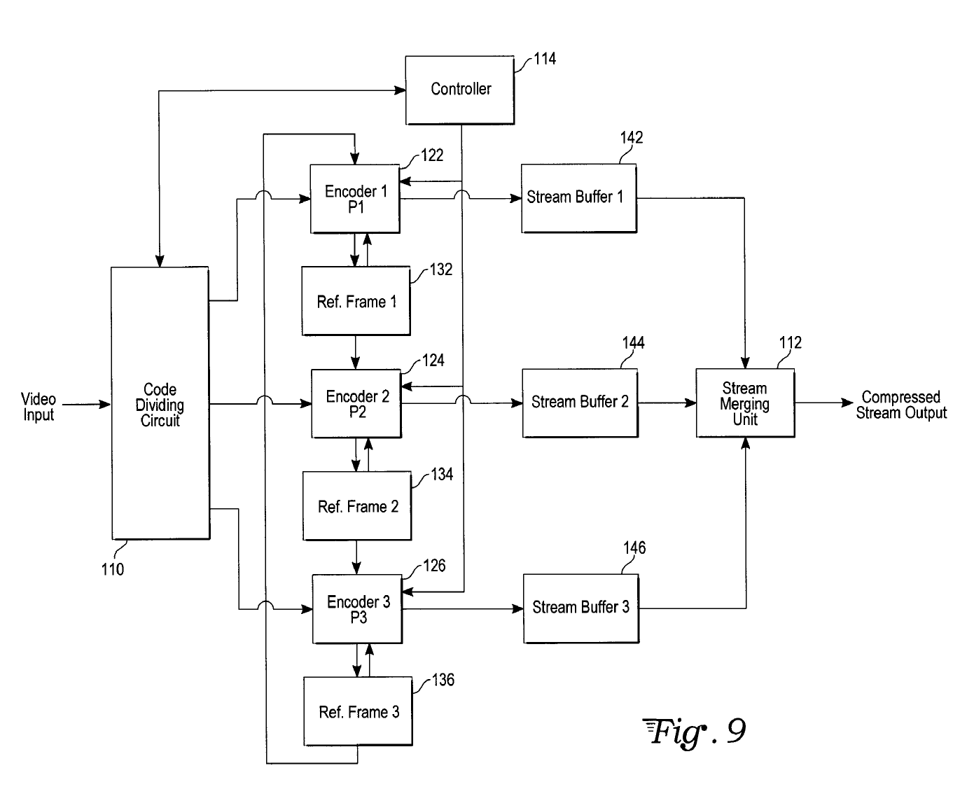

FIG. 8 shows an exemplary timing diagram of the encoding process. The frames are received sequentially each period of 1T of time. A progress bar at the bottom of FIG. 8 shows the progress of the encoding process of a frame for each encoder stage. In FIG. 8, the encoder 1 is termed P1, the encoder 2 is termed P2, and the encoder 3 is termed P3. Each encoder P1, P2, and P3 can use up to 3T of time to encode a frame. The encoder P1 can start with frame 1 of a sequence of frames once the input frame 1 is available. In other embodiments disclosed herein, the encoder P1 can start with the encoding process when only portions of the frame are available. The other encoders each start after another period of 1T as shown in FIG. 8.

In general, the input video streams can be distributed on M processors. Each frame can be encoded by a single processor. No slices within frames are required and, hence, no boundary effects appear. The encoding process of a frame and even the decode process in a decoder can start with two conditions being fulfilled: that sufficient data of the input frame and sufficient data of the reference frame (the reconstructed previous frame) are available. The portion of the reference frame which is required for the encoding or decoding process is the reference frame area which is scanned for motion estimation. Motion estimation only needs the reference frame area of the reconstructed reference frame to determine the motion information. In the embodiment shown in FIGS. 6A and 6B, the search range (the reference frame area) vertically is limited to about ⅓ of the vertical size of the frame and hence minor or negligible quality loss is expected as the search range horizontally is not limited and most movements in videos are horizontal.

Another issue in video encoding and decoding is the scheduling of deblocking. Deblocking is required in some profiles of video standards like ITU H.264 and is used to enhance the image quality and to remove blocking artifacts as discussed above. The H.264 standard defines that deblocking operations shall be performed after the complete frame was reconstructed. This means that the whole reference frame must be stored and deblocking can only start after the last macroblock in the frame has been processed. However, if the macroblocks are stored in a strictly increasing order (each line from left to right and the lines from top down to the bottom) the deblocking operation can be performed immediately when the macroblock was reconstructed. This approach is called deblocking-on-the-fly and is state-of-the-art. Deblocking-on-the-fly leads to lower memory transfers and lower memory requirements and can only be applied on whole frames.

Although slice-level parallelism enables high parallelism, deblocking cannot be performed at the slice boundaries. Existing approaches use tricks to overlap the slice areas to overcome this problem. However, the deblocking of a lower slice can start only when deblocking of the upper slice is completed. Hence, deblocking-on-the-fly cannot be performed for all slices of a frame in slice-level parallelism. Consequently, this leads to higher memory usage and higher memory transfers as all slices that could not be deblocked on the fly have to be reloaded and deblocked after the whole frame has been reconstructed.

One of the advantages of the proposed method and system of the present invention enables deblocking-on-the-fly as whole frames are processed instead of slices. Therefore, the memory transfers can be kept small. Moreover, as the present invention uses frame-level parallelism, no slices are required which leads to a better coding efficiency. In addition to the aforementioned advantages, the present method has lower latency than GOP-level parallelism. The degraded coding efficiency of slice-level parallelism is analyzed by Chen et al. in “Towards Efficient Multi-Level Threading of H.264 Encoder on Intel Hyper-Threading Architectures.”

FIG. 9 shows an exemplary embodiment of an apparatus of the present invention. A code dividing circuit 110 demultiplexes frames of a video sequence on M processors. The example circuit shown in FIG. 9 has three processors P1 122, P2 124, and P3 126 which can be interconnected over dual ported memories 132, 134, and 136. Each of the processors P1 122, P2 124, and P3 126 receives frames from the code dividing circuit 110.

Each of the M processors (in FIG. 9 the processors P1 122, P2 124, and P3 126) can encode a single frame (intra or predicted) in M times T time intervals (three times T time intervals due to three processors as shown in FIG. 8).

Each processor writes the reconstructed frame to a memory which can be accessed by one or more other processors. According to FIG. 9, the processor P1 122 writes the reconstructed frame to the first memory 132, the processor P2 124 to the second memory 134, and the processor P3 126 to the third memory 136. In FIG. 9 the first memory 132 can be written by the processor P1 122 and can be read by the processors P1 122 and P2 124. The second 134 and third 136 memories are accessed accordingly.

The output streams of the processors are forwarded to stream buffers 142, 144, 146 and a stream merging unit 112 merges the single streams to a single output stream. In FIG. 9 each of the processors P1 122, P2 124, and P3 126 writes the calculated output stream to one of the associated buffers 142, 144, 146. The stream merging unit 112 can be controlled by a controller 114 or can be implemented in a way that it independently assembles the output streams of the processors stored in the frame buffers to a single output stream.

The controller 114 controls the M processors (in the example of FIG. 9 the processors P1 122, P2 124, and P3 126) and can assume that processors stall until enough data of the reference frame are available.

In the example shown in FIG. 9, the code dividing circuit 110 receives the input video stream which is a sequence of frames and schedules the first frame to the first processor P1 122, the second frame to the second processor P2 124, and a third frame to the third processor P3 126 according to the time flow given in FIG. 8. A processor can start processing an intra-mode frame when at least sufficient data of the input frame or the whole input frame are available. Moreover, a processor can start processing a non-intra-mode frame when at least sufficient data of the reconstructed frame are available.

The first frame in the example depicted above by means of the processing architecture given in FIG. 9 is processed by the processor P1 122 which writes the output stream to the first stream buffer 142 and the reconstructed frame to the first memory 132. In the example according to FIG. 8, the processor P2 124 encodes a P-frame and waits until the whole second input frame is available and until sufficient data of the reconstructed frame are available from the processor P1 122. The processor P2 124 then writes the output stream to the stream buffer 144 and the reconstructed frame to the second memory 134. The processor P3 126 also encodes a P-frame and also waits until the whole third input frame is available and until sufficient data of the reconstructed frame are available from the processor P2 124. The processor P3 126 then writes the output stream to the stream buffer 146 and the reconstructed frame to the third memory 136.

However, the assignment of intra-mode frames need not be static as the handling of the next frame shows. Once the processor P1 122 has finished the encoding process of the first frame it can wait until the whole fourth frame (or wait until sufficient data of the fourth frame) is available. As the fourth frame has to be encoded as a P-frame, the processor P1 122 also waits until sufficient data of the reconstructed frame are available from the processor P3 126. The processor P1 122 then writes the output stream to the stream buffer 142 and the reconstructed frame to the first memory 132. In particular embodiments, the reconstructed frame is not written to the first memory 132 in a case where it is not needed. This can happen, for example, when the next frame (as the fifth frame in the example shown in FIG. 8) is an intra frame.

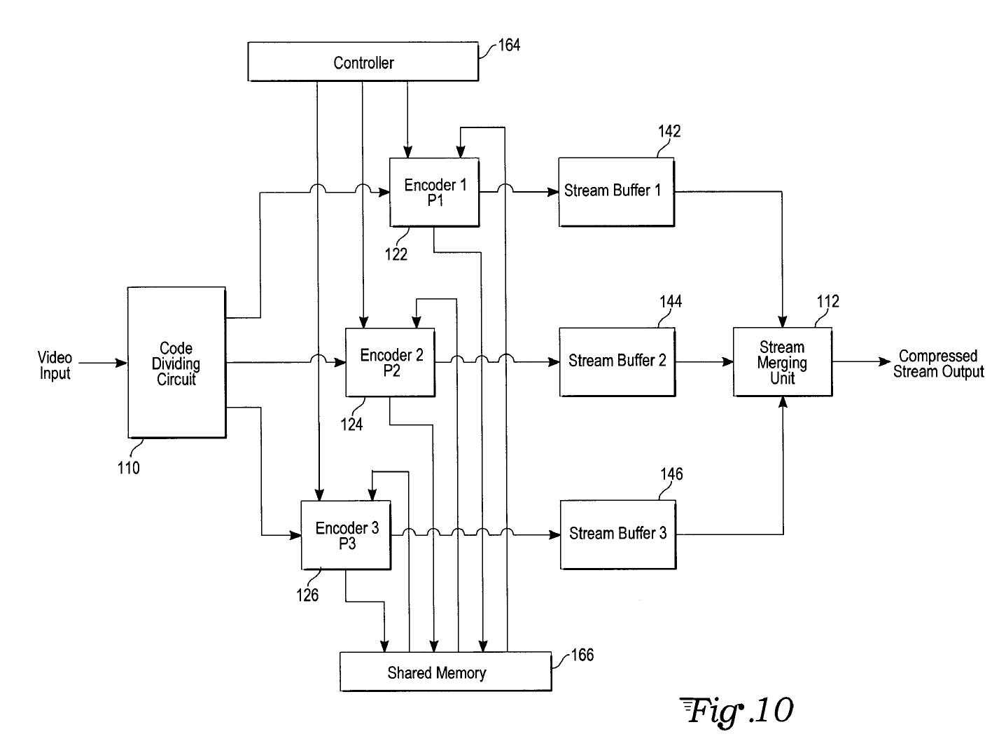

FIG. 10 shows another exemplary embodiment of the present invention which makes use of a shared memory 166. The architecture is arranged similarly to the architecture shown in FIG. 9. However, the processors P1 122, P2 124, and P3 126 access the shared memory 166 to exchange image information. This architecture can be beneficial when the reconstructed image data of several frames have to be used to compute a single frame. This can be the case, for example, for B-frames in more recent video standards like H.264 or when multiple old reference frames are used in P-frames. The controller 164 can control the processors P1 122, P2 124, and P3 126 and the scheduling of data and images.

The architectures of FIG. 9 and FIG. 10 can be implemented as System-on-Chip or using multiple chips, boards, or computers. The reference frame first 132, second 134, and third 136 memories of FIG. 9 for example, can be assigned to two processors only in case only one reference frame is needed for the encoding process. This leads to low memory access bandwidth and is very interesting for applications such as HDTV. Moreover the disclosed method can easily be extended to an arbitrary number M of parallel processors without loss of coding efficiency. The approach is easily scalable and therefore suitable for a wide range of applications (e.g., low power mobile applications to HDTV).

Other advantages of the disclosed method are that no slices are required for parallelization, resulting in a better coding performance and better image quality as artifacts such as horizontal lines do not appear in the image. Moreover, deblocking on the fly is possible, resulting in fewer memory transfers. Another advantage over GOP-level parallelism is that the present method has lower latency. The processors have M times T of time to compute a frame. Since the method of the invention exploits temporal parallelism, other methods of parallelism as spatial parallelism or functional parallelism can still be applied.

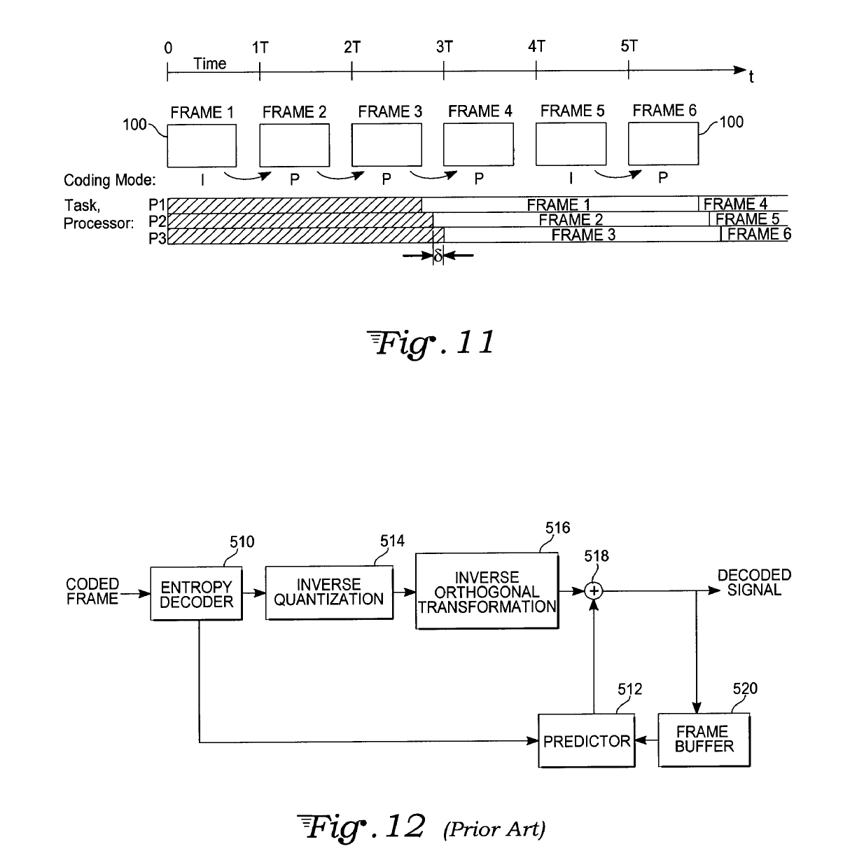

FIG. 11 shows an exemplary timing diagram of the encoding process. The encoding or decoding processes in the processors P1 to P3 are delayed by a time δ. The time shift δ corresponds to a vertical size of the reference frame and is compared to a total height of the image. In other words, the time shift δ must be chosen in a way that at least the reference frame area of the reference frame is available for motion estimation.

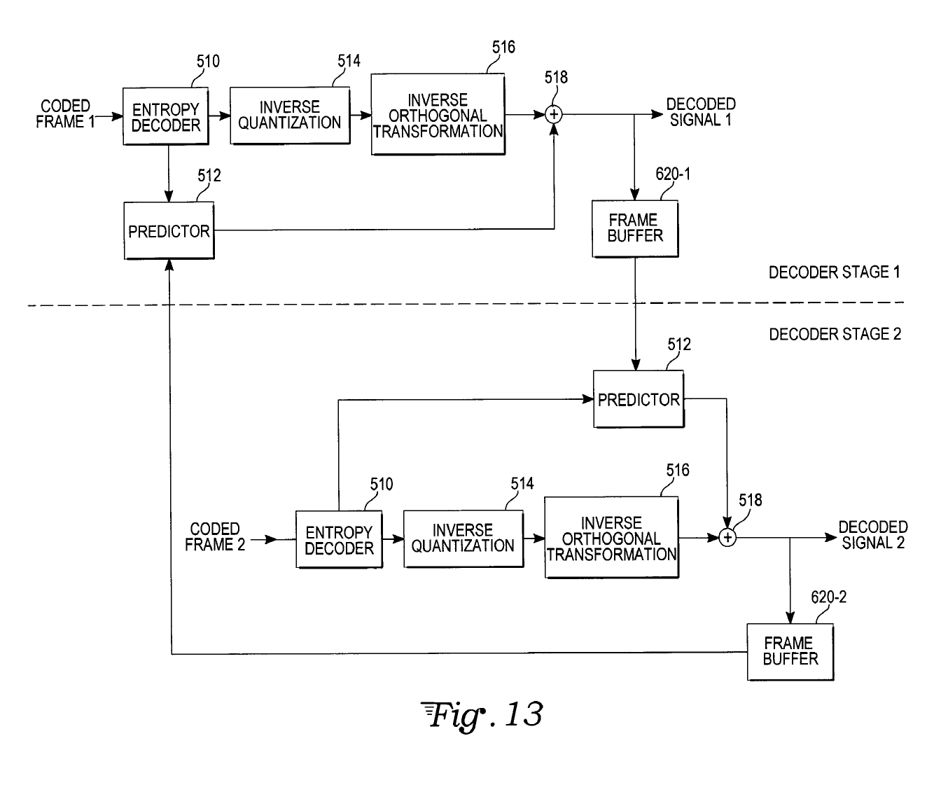

FIG. 13 shows, in simplified form, an exemplary embodiment of the present invention. Two decoders (i.e., the decoder stages 1 and 2) of a type similar to that shown in FIG. 12 are coupled via a first 620-1 and a second 620-2 frame buffer which each can hold a reconstructed frame (or parts of the reconstructed frame). The first frame buffer 620-1 stores the reconstructed current frame of the decoder stage 1 which can be used as a reconstructed previous frame by the decoder stage 2. Similarly, the second frame buffer 620-2 stores the reconstructed current frame of the decoder stage 2 which can be used as a reconstructed previous frame by the decoder stage 1. Therefore, the time flow diagram as depicted in FIG. 5 for an encoding process can be applied for a decoder as well. The decoder stages 1 and 2 work time-displaced and can each use two time periods T to decode a frame. Moreover the frame buffers only need to store a reference frame area as explained above to assure proper prediction.

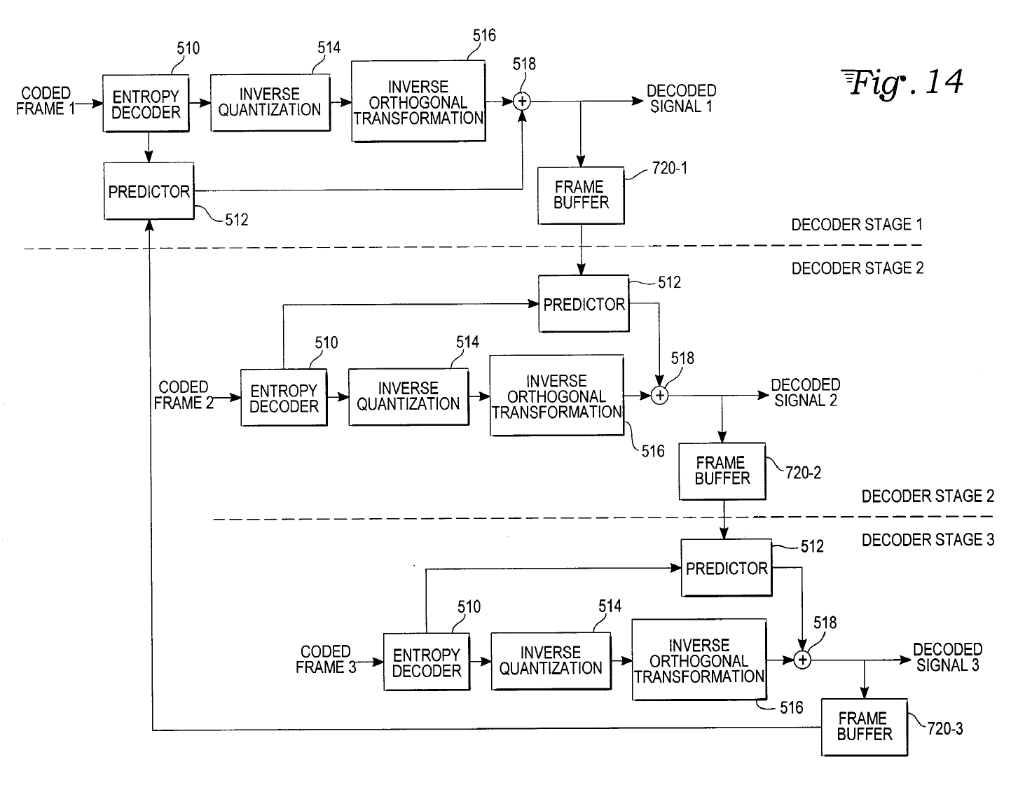

FIG. 14 shows, in simplified form, an exemplary embodiment of the present invention. Three decoders (the decoder stages 1, 2, and 3) of a type similar to that shown in FIG. 12 are coupled via a first 720-1, a second 720-2, and a third 720-3 frame buffer which each can hold a reconstructed frame (or portions of a reconstructed frame). The first frame buffer 720-1 stores the reconstructed current frame of the decoder stage 1 which can be used as a reconstructed previous frame by the decoder stage 2. Similarly, the second frame buffer 720-2 stores the reconstructed current frame of the decoder stage 2 which can be used as a reconstructed previous frame by the decoder stage 3. Finally, the third frame buffer 720-3 stores the reconstructed current frame of the decoder stage 3 which can be used as a reconstructed previous frame by the decoder stage 1. Therefore, the time flow diagrams as depicted in FIG. 8 and FIG. 11 for an encoding process can be applied for the decoder shown in FIG. 14 as well. The decoder stages 1, 2, and 3 work time-displaced and can each use three time periods T to decode a frame. Moreover the frame buffers only need to store a reference frame area as explained above to assure proper prediction.

The only limitations to the decoders according to the present invention shown in FIG. 13 and FIG. 14 are that the stream to be decoded has been encoded using a reference frame area small enough to support the disclosure (which has been explained above) and that no flexible macroblock order (known in most recent video standards) is used. The macroblocks should generally be provided consecutively as described above. However, in a case where a stream has to be decoded which uses a larger reference frame area than required (compare FIG. 4 and FIG. 7) one solution is that the whole reconstructed frames are stored in the frame buffers instead of parts. For example, the MPEG-2 standard has a restriction of the vertical size of the reference frame area.

Despite these limitations the decoders of the present invention have the same advantages as the encoders and allow one to exploit frame-level parallelism and to combine frame-level parallelism with other forms of parallelism, e.g., spatial parallelism and/or functional parallelism. Moreover, artifacts known from slice-level parallelism are avoided and deblocking-on-the-fly is possible.

The hardware architectures as shown in FIG. 9 and FIG. 10 can also be used for decoders according to the block diagrams described and shown in FIG. 13 and FIG. 14. In the case of a decoder, the code dividing unit 110 divides a coded input signal to coded frames and assigns the coded frames one by one to available processors, P1 to PM. The processors P1 to PM time-displaced decode the frames and write the reconstructed current frames to frame buffers which are read by the next processors in the case of FIG. 9 or to the shared memory 166 in the case of FIG. 10. The stream merging unit 112 assembles the output streams of the processors into at least one output stream.

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe a number of processors and memory units per stage. A skilled artisan will recognize that these numbers are flexible and the quantities shown herein are for exemplary purposes only. Additionally, a skilled artisan will recognize that various numbers of stages may be employed for various video stream sizes and applications. These and various other embodiments are all within a scope of the present invention. The specification and drawings are, accordingly, to be regarded in an illustrative rather than a restrictive sense.

What is claimed is:

1. A video encoding apparatus, comprising:
a divider circuit configured to divide an input video stream into a plurality of single frames;
a plurality of encoding units coupled to the divider circuit, each being configured to receive at least one of the plurality of single frames;
a plurality of shared information memory units, each being coupled to at least one of the plurality of encoding units, each of the plurality of encoding units being configured to write a reconstructed frame to the at least one of the plurality of shared information memory units, each of the plurality of shared information memory units being configured to distribute a frame reproduced by a coupled encoding unit to at least one other encoding unit;
a control unit coupled to the plurality of encoding units and configured to determine which frame of a sequence of frames is processed by which of the plurality of encoding units; and
a stream merging unit configured to assemble the coded signals produced by the encoding units into at least one output stream.

2. The video encoding apparatus of claim 1 wherein the control unit is further configured to determine when each of the plurality of encoding units start encoding a frame of the sequence of frames, the control unit being further configured to determine when a sufficient amount of data of the reconstructed frame is available for encoding in subsequent encoding units in each of the plurality of shared information memory units.

3. The video encoding apparatus of claim 1 wherein each of the plurality of encoding units is arranged to operate at a clock rate inversely proportional to a total number of the plurality of encoding units.

4. The video encoding apparatus of claim 1, wherein at least one of the plurality of encoding units is configured to stall an encoding process when the control unit sends a suspend signal to the at least one encoding unit, or to continue the encoding process when the control unit sends a continue signal to the at least one encoding unit.

5. The video encoding apparatus of claim 4, wherein:
the control unit sends the suspend signal to the at least one encoding unit when an entirety of a reference frame area is not available in one of the plurality of information memory units; and
the control unit sends the continue signal when the entirety of the reference frame area is available in the one of the plurality of information memory units.

6. The video encoding apparatus of claim 5, wherein the reference frame is a reconstructed frame.

7. The video encoding apparatus of claim 1, wherein each encoding unit of the plurality of encoding units is configured to stall an encoding process until sufficient data of an input frame are available.

8. The video encoding apparatus of claim 1, wherein each of the plurality of shared information memory units is configured to store at least a reference frame area of a reconstructed reference frame.

9. A method of encoding a video sequence exploiting frame-level parallelism, the method comprising:
partitioning a video sequence into a plurality of frames;
distributing the plurality of frames among a plurality of encoding units;
encoding the plurality of frames according to a picture type assigned to each of the plurality of frames;
assigning at least one shared information memory unit from a plurality of shared information memory units to each of the plurality of encoding units;
storing reconstructed frames created by the plurality of encoding units to at least one of the plurality of shared information memory units;
controlling which frame of the plurality of frames is processed by a specific one of the plurality of encoding units; and
determining when a sufficient amount of data of the reconstructed frames are available for encoding in each of the information memory units.

10. The method of claim 9, further comprising operating each of the plurality of encoding units at a clock rate inversely proportional to a total number of the plurality of encoding units.

11. The method of claim 9 further comprising controlling when each of the plurality of encoding units begin encoding a frame of the sequence of frames.

12. The method of claim 9 further comprising assembling coded signals produced by the plurality of encoding units into at least one output stream.

13. The method of claim 9, further comprising stalling an encoding process of at least one of the plurality of encoding units after receiving a suspend signal.

14. The method of claim 9 further comprising continuing an encoding process of at least one of the plurality of encoding units after receiving a continue signal.

15. The method of claim 9, further comprising sending a suspend signal to at least one of the plurality of encoding units when an entirety of a reference frame area is not available in the information memory unit and sending a continue signal at a time when the entirety of the reference frame area is available in the information memory unit.

16. The method of claim 9 further comprising at least one encoding unit of the plurality of encoding units stalling the encoding process until sufficient data of an input frame are available.

17. The method of claim 9 further comprising selecting the shared information memory unit to be capable of storing at least the reference frame area of the reconstructed reference frame.

18. A video decoding apparatus coupled to receive an encoded input video stream having a sequence of coded frames, the apparatus comprising:
a divider circuit configured to divide the input video stream into a plurality of single coded frames and transfer at least one of the plurality of single coded frames to a plurality of decoding units;
a plurality of shared information memory units each being coupled to at least one of the plurality of decoding units, each of the plurality of decoding units being configured to write a reconstructed frame to the at least one of the plurality of shared information memory units, each of the plurality of shared information memory units being configured to distribute a frame reproduced by a coupled decoding unit to at least one other decoding unit;
a control unit coupled to the plurality of decoding units and configured to determine which frame of a sequence of frames is processed by which of the plurality of decoding units; and
a stream merging unit configured to assemble the coded signals produced by the decoding units into at least one output stream.

19. The video decoding apparatus of claim 18 wherein the control unit is further configured to determine when each of the plurality of decoding units start decoding the frame of the sequence of coded frames, and further configured to determine when a sufficient amount of data of the reconstructed frame is available for decoding in subsequent decoding units in each of the plurality of shared information memory units.

20. The video decoding apparatus of claim 18 wherein each of the plurality of decoding units is arranged to operate at a clock rate inversely proportional to a total number of the plurality of decoding units.

21. The video decoding apparatus of claim 18, wherein at least one of the plurality of decoding units is configured to stall a decoding process when the control unit sends a suspend signal to the at least one decoding unit or to continue the decoding process when the control unit sends a continue signal to the at least one decoding unit.

22. The video decoding apparatus of claim 21, wherein:
the control unit sends the suspend signal to the at least one decoding unit when an entirety of a reference frame area is not available in the information memory unit; and
the control unit sends the continue signal when the entirety of the reference frame area is available in the information memory unit.

23. The video decoding apparatus of claim 22, wherein the reference frame is a reconstructed frame.

24. The video decoding apparatus of claim 18, wherein each decoding unit of the plurality of decoding units is configured to stall a decoding process until sufficient data of an input frame are available.

25. The video decoding apparatus of claim 18, wherein each of the plurality of shared information memory units is configured to store at least a reference frame area of a reconstructed reference frame.

26. A method of decoding a coded video sequence exploiting frame-level parallelism, the method comprising:
partitioning a video sequence into a plurality of coded frames;
distributing the plurality of coded frames among a plurality of decoding units;
decoding the plurality of coded frames according to a picture type assigned to each of the plurality of coded frames;
assigning at least one shared information memory unit from a plurality of shared information memory units to each of the plurality of decoding units;
storing reconstructed frames created by the plurality of decoding units to at least one of the plurality of shared information memory units;
controlling which frame of the plurality of coded frames is processed by a specific one of the plurality of decoding units; and
determining when a sufficient amount of data of the reconstructed frames are available for decoding in each of the information memory units.

27. The method of claim 26, further comprising operating each of the plurality of decoding units at a clock rate inversely proportional to a total number of the plurality of decoding units.

28. The method of claim 26 further comprising controlling when each of the plurality of decoding units begin decoding the frame of the sequence of frames.

29. The method of claim 26 further comprising assembling coded signals produced by the plurality of decoding units into at least one output stream.

30. The method of claim 26, further comprising stalling a decoding process of at least one of the plurality of decoding units after receiving a suspend signal.

31. The method of claim 26 further comprising continuing a decoding process of at least one of the plurality of decoding units after receiving a continue signal.

32. The method of claim 26, further comprising sending a suspend signal to at least one of the plurality of decoding units when an entirety of a reference frame area is not available in the information memory unit and sending a continue signal at a time when the entirety of the reference frame area is available in the information memory unit.

33. The method of claim 26 further comprising at least one decoding unit of the plurality of decoding units stalling the decoding process until sufficient data of an input frame are available.

34. The method of claim 26 further comprising selecting the shared information memory unit to be capable of storing at least the reference frame area of the reconstructed reference frame.
